(19) United States
(12) Patent Application Publication
(10) Pub. No.: US 2010/0112279 A1
(43) Pub. Date: May 6, 2010

(54) DIFFUSION-TOLERANT DATA MATRIX DESIGNS

(76) Inventor: Joseph James McIntosh, Painted Post, NY (US)

Correspondence Address: CORNING INCORPORATED, SP-TI-3-1, CORNING, NY, 14831, US

(21) Appl. No.: 12/578,990

(22) Filed: Oct. 14, 2009

Related U.S. Application Data
(60) Provisional application No. 61/110,221, filed on Oct. 31, 2008.

(51) Int. Cl. B32B 3/12; B28B 1/00; B32B 3/00

(52) U.S. Cl. 428/116; 264/630; 428/195.1; 347/9

(57) ABSTRACT

Barcode markings such as two-dimensional data matrices, and methods for using them, according to which ceramic or other articles are imprinted with condensed barcode patterns having printed bars or cells of reduced dimensions as compared with the dimensions of the non-printed bars or cells, and with further processing or use of the articles thereafter causing dilation of the condensed bar or cell patterns to provide patterns with printed and non-printed bars or cells of comparable dimensions.

### CROSS-REFERENCE TO RELATED APPLICATIONS

This application claims the benefit of priority under 35 U.S.C. §119(e) of U.S. Provisional Application Ser. No. 61/110221 filed on Oct. 31, 2008.

### BACKGROUND

1. Field

The present disclosure is in the field of ceramic manufacturing and more particularly relates to improved methods and systems for encoding manufacturing information onto or into ceramic products in the course of manufacture.

2. Technical Background

Ceramic product manufacturing generally involves the initial shaping of product preforms from flowable or shapeable mixtures of ceramic precursor materials, such mixtures typically comprising particulate glassy or crystalline raw materials including mineral raw materials of various forms dispersed in liquid vehicles. The shaped preforms thus provided are generally then fired at relatively high temperatures to sinter or reaction-sinter the raw materials into hard and strong products.

Examples of technical ceramics made by these processes include the ceramic honeycomb structures used to make anti-pollution devices for treating combustion engine exhaust gases, e.g., catalytic converter substrates for automobile exhaust systems, and diesel particulate filters for diesel-powered vehicles. The ceramic honeycomb structures for both of these applications comprise a matrix of relatively thin interconnecting ceramic webs forming a plurality of adjoining, parallel, gas-conducting honeycomb channels or cells traversing the structures. In honeycomb structures used as ceramic catalyst substrates, cell densities are measured by cells per square inch of honeycomb cross-sectional area measured in a plane transverse to the direction of channel orientation. Those cells are typically defined by surrounded cell walls having of slight thickness. Ceramic honeycomb structures used as diesel particulate filters may have lower cell densities and thicker cell walls. Most commercial ceramic honeycomb products additionally include an outer skin encircling the channel array.

Commercial ceramic honeycombs of these types are formed by extrusion through honeycomb extrusion dies, with the wet honeycomb extrudate then being cut transversely into wet green honeycomb sections for subsequent drying and later firing. The dried green honeycombs resulting from the drying step are typically fired by heating to temperatures of at least 1100° C., more often much higher, to sinter or reaction-sinter the ceramic raw materials into strong, integral honeycomb shapes. In some cases, the fired honeycomb bodies may be subjected to secondary firing treatments for purposes such as selective channel plugging, or to treat or add to the encircling outer skins of the structures, typically although not necessarily at somewhat lower temperatures. Thereafter, they are in some cases processed through a coating procedure that applies catalyst-containing or filtration-enhancing coatings to the gas-contacting surfaces of the cell walls.

Wet extruded honeycomb shapes as well as dried honeycomb preforms, whether designed for use as thin-walled catalyst supports or heavier walled exhaust filters, are relatively fragile as formed and until subjected to high temperature firing. Further, the processes for their production necessarily subject them to substantial mechanical and thermal stresses during the forming, drying, handling, and firing steps involved in their manufacture. Defects arising from such stresses can thus arise at any one of a number of stages throughout the production process.

One conventional approach for tracking of honeycomb products for later identification and/or recall in the event of field performance problems has involved the post-production marking of honeycomb products with alphanumeric production codes prior to shipment. These codes are typically keyed to secondary production records retained by the manufacturers that can later be referenced for the details of product manufacturing history. One difficulty with such approaches, however, is that ware being collected for marking from a single firing batch, although sharing a common firing history, will not necessarily share a common extrusion, handling, and/or drying history. Thus production codes applied only after firing are not adequate for the purpose of identifying hidden defects arising from a particular extruder or extrusion die, or from a specific drier or piece of handling equipment.

Attempts to address the need for more comprehensive production tracking have included systems and methods for marking production pieces with encoded information earlier in the production process, i.e., after extrusion or after drying as well as after firing of the ware. However, no completely satisfactory system for marking ceramic honeycombs with the required production information has yet been developed. Among the particular problems yet to be addressed are those relating to the poor readability of production markings applied to wet or dry honeycombs prior to subjecting them to firing or other high temperature processing. Ink fading and/or pattern degradation have made the use of modern coding systems such as bar codes and 2-D bar codes or data matrices unusable, due the significant loss of encoded information that results from image blurring or data cell overlap cell resulting from firing.

### SUMMARY

The present systems and methods address the above-described pattern resolution problems through the adoption of improved designs for information codes including one-dimensional (1-D) and two-dimensional (2-D) barcodes or data matrices. In important aspects, these improvements involve taking the expected diffusion growth or dilation of printed bars or cells making up such markings into account in the design of the initially printed patterns of those bars or cells.

In particular embodiments of the disclosed methods, data cells or bars to be applied to ceramic products in the green (or unfired) state are applied in a selectively condensed fashion. That is, they are applied with the printed bars or cells (as opposed to the non-printed bars or cells) controlled to dimensions smaller than targeted for the same printed bars or cells in the final or fired marking. In the case of 2-D barcodes, for example, the originally printed cell dimensions are set at less than 100% of the targeted final (fired) printed cell dimensions, for example at less than 90%, or less than 80%, or even less than 70%, of the targeted final cell dimension.

Thereafter, as the green products are fired, the printed cells or bars dilate via ink diffusion to produce post-fired marks with larger, but still not overlapping, printed bars or cells. The fired marks thus exhibit substantially reduced pattern degradation when compared with conventionally applied marks subjected to equivalent firing treatments. Advantageously, the extent of printed bar or cell condensation designed into the initially printed mark may be adjusted in individual cases according to the level of bar or cell dilation anticipated in production. Thus manufacturing history data can be effectively encoded via data matrix printing even on products that are otherwise very difficult to mark.

In broad aspect, then, the methods disclosed herein include a method of marking an article with digitally encoded information which comprises the step of printing a condensed bar or cell pattern encoding said information onto the surface of the article. By a “condensed” bar or cell pattern is meant a pattern wherein the dimensions of width or area of each of the printed bars or cells are reduced as compared with the dimensions of the non-printed bars or cells of the pattern. The overall size of the condensed barcode pattern or marking is generally not affected in accordance with this method, in that the spacings between the bars or cells in the pattern are generally not reduced. Embodiments of those methods that comprise imprinting condensed patterns for 2-D barcodes offer particular advantages.

In another aspect the present disclosure encompasses a method of providing a fired ceramic article marked with a 2-D barcode. That method comprises, first, imprinting a surface of a green preform for the ceramic article with a 2-D barcode having a condensed cell pattern, i.e., a pattern comprising non-printed cells and condensed printed cells. Thereafter, the green preform is fired to a temperature sufficient to convert the preform to the fired ceramic article and to convert the condensed cell pattern to a dilated cell pattern incorporating dimensionally expanded or dilated printed cells. The dilated cell pattern is generally a product of the high-temperature diffusion of the ink used to print condensed cells onto the preform surface occurring during the firing step of the method.

In yet another aspect, the present disclosure provides articles of manufacture having surfaces imprinted with 2-D barcode markings of improved legibility or resistance to high temperature pattern degradation. In accordance with this aspect the imprinted articles, e.g., green ceramic product preforms such as green ceramic honeycombs, will have barcode markings characterized by cell patterns incorporating a combination of non-printed cells and condensed printed cells. Each of the condensed printed cells will have dimensions of area below those of the non-printed cells, in some embodiments being not more than 90% of the areas of the non-printed cells.

In the case of articles such as fired ceramic honeycombs, the surfaces are imprinted with 2-D barcode markings characterized by cell patterns incorporating a combination of non-printed cells and dilated printed cells. The dilated printed cells are substantially equivalent in area to the non-printed cells after firing, but may exhibit uneven borders and reduced coloration indicative of marking ink diffusion during firing. Nevertheless they will in all cases retain light reflectance or absorption characteristics sufficient to preserve a contrast ratio of at least 20% as between the printed and non-printed cells.

Further embodiments of the disclosure include methods for preserving pre-fired ceramic product tracking information within barcode markings disposed on the surfaces of post-fired ceramic products. Such methods include the steps of imprinting a surface of an unfired preform for the ceramic product with a marking that encodes pre-fired product tracking information within a condensed, high-contrast barcode pattern, and then firing the unfired preform and barcode pattern. The step of firing involves heating the preform and barcode pattern to a temperature sufficient to cause partial diffusion of the inked areas of the barcode, along with conversion of the unfired preform to a fired ceramic product.

These methods are best enabled through the use of a “diffusion-tolerant” printed two-dimensional barcode or data matrix comprising a two-dimensional array of contrasting light and dark cells for encoding digital zero (off) and one (on) values. The dark cells in the matrix will differ in unit dimensional area from the light cells, with the respective areas of each cell type being chosen such that those cells tending to diffuse or dilate in the course of a firing treatment or other condition of use will be of smaller area. Generally the smaller cells are the printed cells, most often formed in dark rather than light ink, and are at least 5% smaller in unit dimensional area than the larger cells.

### BRIEF DESCRIPTION OF THE DRAWINGS

The present methods are further described below with reference to the appended drawings, wherein:

FIGS. 1a and 1b are schematic views of the dilation of a segment of a 2-D barcode pattern in accordance with prior art;

FIGS. 2a and 2b are schematic views of the dilation of a segment of a 2-D barcode in accordance with one embodiment of the present disclosure;

FIGS. 3a and 3b schematically illustrates the dilation of a condensed 16-character barcode pattern;

FIGS. 4i, 4ii, 4iii, and 4iv illustrate a calibration series for evaluating high-temperature ink diffusion in a 2-D barcode pattern;

FIGS. 5i, 5ii, and 5iii illustrates a calibration series for evaluating high-temperature ink diffusion in a 2-D barcode pattern; and

FIG. 6 is a photograph of a fired ceramic honeycomb imprinted with a barcode calibration series marking.

### DETAILED DESCRIPTION

While the present methods have wide utility for the application of barcode or other encoded information marks to a variety products produced or used in environments wherein diffusion or other blurring of those marks may occur, they have principal application to the use of barcodes in the production of fired ceramic articles such as the ceramic honeycombs used for engine exhaust treatment. The following description is therefore presented with specific reference to such applications even though offered for purposes of illustration only and without any intention to limit the scope or fields of application of those methods as herein described.

As noted above, in order to promptly identify and control the incidence of hidden manufacture defects that may arise from several different sources, quality control systems that can fully track manufacturing variables relating to product composition and processing history are required. Tracking systems enabling ceramics manufacturers to trace the production histories of products sold, including information as to manufacturing date, manufacturing plant, specific production equipment, targeted batch composition and batch processing information, and specific extrusion, drying and firing conditions, are presently being developed to provide these capabilities.

An important element of advanced tracking strategies for the production of ceramic products such as ceramic honeycombs is the ability to apply encoded production information directly to the ceramic honeycombs during the process of manufacture. This can be enabled through the development of customized marking compositions, processes and equipment for the application of one-dimensional or two-dimensional barcodes to the surfaces of the ceramic honeycombs.

As currently practiced, the manufacture of ceramic honeycombs for gasoline or diesel engine exhaust treatment involves the marking of the surfaces of the products with two-dimensional barcodes or data matrices using high-temperature-capable inks. These barcodes are comprised of a matrix or grid of squares or dots digitally encoding selected underlying data that can be read by a scanner or camera. The underlying data may consist of identifying numbers or so-called “license plates”, unique to each part, that are keyed to manufacturing data maintained in separate databases. Alternatively or in addition, they may directly encode part manufacturing information such as a date of manufacture, the plant of origin, and the like. It is important for their intended use that these marks remain legible after firing and throughout the useable lifetime of the product, in order to enable so-called “full piece traceability” whereby the origin and manufacturing history of the product can be accessed at a later date.

The surfaces of green ceramic honeycomb articles, however, present a marking environment that is particularly hostile toward barcode marking inks, with losses of pattern definition frequently occurring through reductions in cell-to-cell contrast or ink diffusion during firing. Fired ceramic honeycombs composed at least predominantly (more than 60% by weight) of cordierite and aluminum titanate ceramic materials generally undergo extensive reaction-sintering during firing, being examples of important commercial honeycomb compositions that are particularly difficult to mark. Fired honeycombs composed of silicon carbide can present similar problems. Such honeycombs often require heavier ink layers to preserve printed pattern contrast after firing, but the heavier ink layers are more susceptible to ink diffusion and pattern blurring than conventional layers, frequently resulting in images that are too blurry to be read.

FIG. 1 of the drawings presents a schematic illustration of the effects of ink diffusion on the readability of 2-D barcodes. Pattern (a) in FIG. 1 is a magnified view of a 9-cell portion of a 2-D barcode marking as printed in accordance with prior art, wherein cell-to-cell contrast and well-defined boundaries between the dark (printed or digital “on”) and non-printed (white or digital “off”) cells are provided. Pattern (b) in FIG. 1 is representative of the same mark portion as it might appear after firing to a high temperature on a ceramic surface, as indicated by firing arrow F in FIG. 1. Thus ink diffusion produces a significant dilation of the printed or dark cells in pattern (b). The result of cell dilation is a significant increase in “on” or dark cell area and a corresponding decrease in the area of each of the “off” or white cells. The large imbalance in cell size as between the “on” and “off” cells of pattern (b) presents substantial pattern decoding difficulties.

Unfortunately the use of expanded barcode fields with large data cells does not effectively address such pattern diffusion problems. Larger marking patterns require increased ink usage, extend printing and drying times, risk additional coating stresses in fired parts, and introduce equipment and processing complexities relating to the printing and reading of large barcode patterns on curved honeycomb skin surfaces of limited area and small curvature radius.

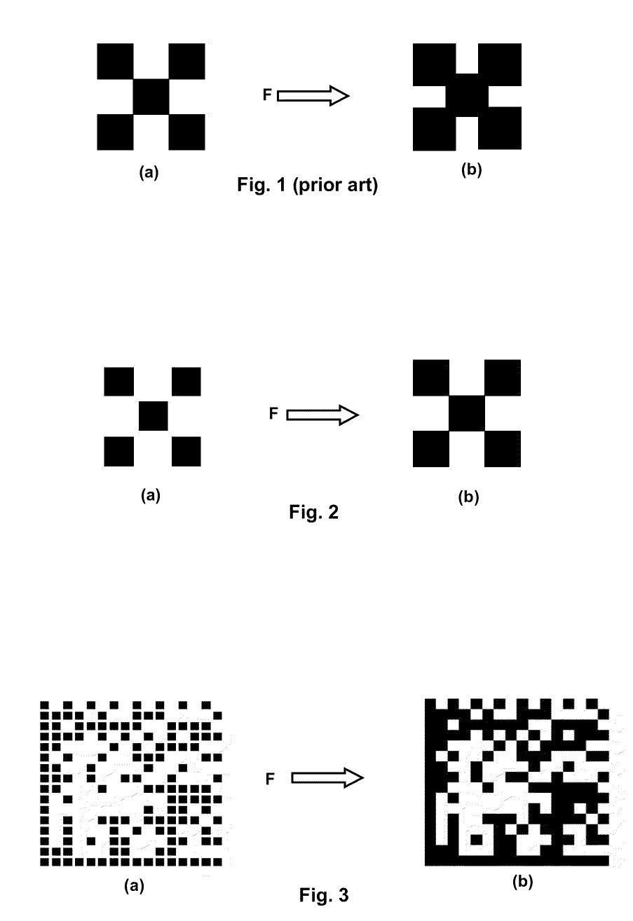

FIG. 2 of the drawing schematically illustrates the advantages of the use of a condensed 2-D barcode pattern to address the problem of pattern degradation illustrated in FIG. 1. Pattern (a) in FIG. 2 is a magnified view of a 9-cell portion of a 2-D barcode marking of approximately the same overall size as the patterns in FIG. 1, but printed in a condensed format. That is, each printed dark or “on” cell in the data matrix is reduced in area by about 30%, with an accompanying enlargement of the light or “off” cells in the matrix, since the overall size of the pattern segment does not change. Pattern (b) to the right of firing arrow F in FIG. 2 represents a marking such as depicted in pattern (a) as it might appear after firing in contact with a ceramic surface. Thus diffusion of the ink at high ceramic firing temperatures again results in a significant dilation of the printed or dark cells, but in the case of condensed pattern (a), however, cell dilation brings the dark cells in pattern (b) into close size alignment with the white cells of the fired pattern.

Using condensed barcode patterns to counteract ink diffusion effects avoids losses of pattern resolution relating to cell overlap, and at the same time enables the use of somewhat higher ink loadings to preserve or enhance cell-to-cell contrast in the post-fired patterns. As noted above, the extent of printed-cell area reduction selected for any particular barcode design may vary from ceramic to ceramic, ink to ink, and process to process, but the ink loadings and reductions in printed cell area providing the highest readability in the post-fired markings may readily determined by routine experiment. Thus individual printed cell areas, while in all cases being less than 100% of the non-printed or “off” cell areas, may in some embodiments be as high as 95% of the areas non-printed cells. Variations in printed cell areas may of course also depend on whether the printed cells are square or circular in shape, and whether they are light (e.g., white) or dark (e.g., black or other light-absorbing color) in the post-fired mark.

The amount of information required to be encoded in any particular barcode mark will vary depending upon the requirements of the particular tracking system to be employed. 2-D marks encoding from as few as 10 numerical digits or less to as many as 36 alphanumeric digits or more are useful for the tracking of ceramic products, with marks encoding 16 alphanumeric digits being considered typical. Sixteen-digit patterns can incorporate sufficient information for most manufacturing purposes, are readily printable in machine-readable sizes on the curved surfaces of ceramic honeycomb shapes, and offer excellent resistance to pattern blurring and loss of encoded data when applied in accordance with the present disclosure.

FIG. 3 of the drawing illustrates the principle of 2-D barcode pattern condensation as it may be employed to counteract ink diffusion effects occurring during the firing of a 16-digit 2-D barcode data matrix applied to a green ceramic surface prior to the firing of the green ceramic. Pattern (a) is a schematic representation of a condensed barcode pattern that may suitably be printed on the green (pre-fired) ceramic surface prior to firing in order to produce a balanced post-fired mark. Pattern (b) schematically illustrates a desirable post-fired barcode design, i.e., a data matrix exhibiting good dark-white cell size balance and contrast after firing as indicated by firing arrow F. The amount of cell condensation shown in FIG. 3 is illustrative only; the actual level of condensation to be used in any particular case will depend directly upon the amount of ink diffusion expected.

An important consideration pertaining to the design of any condensed 2-D barcode pattern intended for use in accordance with the present disclosure is the level of contrast required to be maintained between the dilated printed cells and non-printed cells after firing-induced ink diffusion. Methods of use wherein the dilated cell pattern retains a cell contrast ratio of at least 20%, or in some embodiments at least 50% or even at least 80% between those cells (as determined by cell light reflectance or light absorption values) offer significant advantages for symbol decoding, especially in the case of high data density patterns. For applications relating to the barcoding of ceramic honeycombs, 2-D patterns having data densities sufficient to encode at least 6 alphanumeric characters, more advantageously at least 16 alphanumeric characters, can permit the direct encoding of pre-firing process data. Image contrast is particularly important at higher data densities since honeycomb surface curvatures tend to limit the useful overall sizes of the barcode patterns. Patterns not exceeding 10 cm by 10 cm in size are typically used.

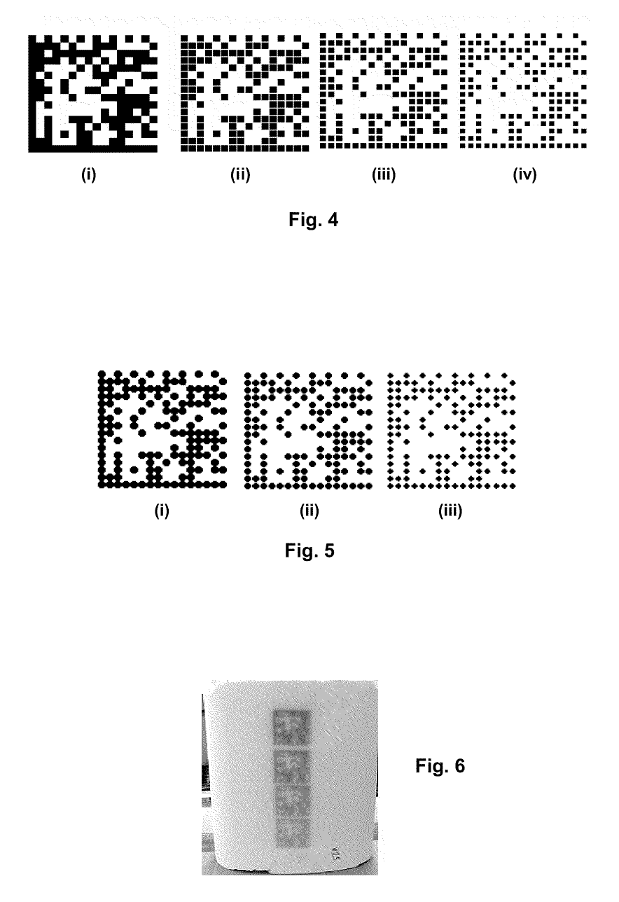

To determine an appropriate level of printed cell condensation suitable for use with any particular ink formation, green ceramic to be marked, or firing cycle to be employed, a calibration series of condensed barcode patterns may be applied to a test ceramic surface and fired. FIG. 4 of the drawings is a schematic illustration of such a series, comprising a group of four 2-D barcode patterns (i)-(iv), all of which encode the same digital information. Left-most pattern (i) in the series is printed without data cell condensation, while the remaining three patterns are printed over a range of increasing condensation, i.e., with incremental reductions in printed cell size, to a maximum level of condensation (iv). Firing a test ceramic honeycomb imprinted with such a series will produce cell dilation in all of the patterns, with the level of dilation best suited to provide maximum decoding accuracy upon a reading of the fired mark being readily determinable by inspection or routine decoding of the marks. FIG. 5 of the drawing illustrates a similar calibration series (i)-(iii), ranging from uncondensed pattern (i) to highly condensed pattern (iii). That series is useful for determining appropriate levels of cell condensation for a case where the printed (dark) cells of the matrix are generally circular rather than square in shape.

FIG. 6 of the drawing illustrates the application of a condensation calibration series for a square-cell 2-D barcode pattern to a ceramic article. The figure comprises a photograph of the curved side surface or skin of a fired ceramic honeycomb of aluminum titanate composition upon which a 2-D barcode condensation calibration series similar to that shown in FIG. 4 has been imprinted. The uppermost barcode pattern was imprinted without dark-cell condensation, while condensation levels are increased toward the lowermost pattern with the highest condensation level. Barcode printing was carried out prior to the firing of the honeycomb by depositing a high-temperature ink on the skin surface with an inkjet printer. Ink application was at twice the conventional loading to compensate for expected ink diffusion and thereby insure adequate dark-cell/light-cell contrast following firing.

As the photograph of FIG. 6 suggests, the level of post-fired pattern blurring in this series of marks is found to increase from the most highly condensed bottom marking to the uncondensed top marking, with a substantial decrease in the areas of the non-printed or white cells in the latter. On the other hand, the decreased level of dark-cell/light-cell contrast in the most highly condensed bottom marking would make decoding of the pattern difficult under some scanning conditions. Close inspection of this series indicated that a level of dark-cell condensation close to those employed in printing the second and third marking in the series should be selected for a condensed barcode design providing optimum post-fired pattern readability in actual production. Dilated 2-D barcode markings with condensation levels selected in this manner, if designed to incorporate information redundancy and error-correcting encoding according to conventional practice, can offer error-free decoding even in cases where up to 30% of the marking is obliterated or otherwise rendered unreadable.

Known high temperature marking inks and barcode printing and scanning systems can be successfully adapted to support the practice of the methods as hereinabove described. In an exemplary procedure, a high temperature marking ink is prepared by combining a silicate glass frit with a powdered manganese oxide colorant in a pine oil vehicle. The glass and oxide powder are ball-milled as necessary to achieve particle sizes in the range of about 10-20 um in the final ink, wherein the solids fraction consists of 30% glass and 70% MnO2 by weight. The glass is an alkali aluminosilicate glass consisting, in mole percent, of about 8.1% K2O, 8.1% Na2O, 15.4% ZnO, 1.3% Al203, 2.9% ZrO2 and 64.3% SiO2. The ink is applied to the skin of a green ceramic honeycomb of aluminum titanate composition in the configuration of a condensed 2-D barcode pattern using a non-contact inkjet printer incorporating ink nozzles of sufficiently large aperture to freely pass the particulate glass and colorant.

Following ink application, the inked barcode is dried using a hot air blower, and the green ceramic honeycomb with applied ink is introduced into a kiln wherein it is fired to a temperature sufficient to convert the green ceramic honeycomb into a fired honeycomb comprising a predominating crystalline phase of aluminum titanate. An inspection of the fired honeycomb reveals that ink diffusion and printed cell dilation have occurred in the barcode marking. However, utilizing high-temperature ink of the type described, the marking exhibits good dark-cell/light-cell size balance as well as cell-to-cell brightness contrast that is more than adequate for full retrieval of the digitized information encoded in the barcode pattern.

While the foregoing description includes specific examples and embodiments of the presently disclosed methods and systems, such examples and embodiments have been offered for purposes of illustration only, as it will be apparent from the broader descriptions above that a wide variety of alternative embodiments may be adopted by the artisan for particular purposes within the scope of the appended claims.

What is claimed is:

1. A method of marking an article with digitally encoded information which comprises the step of printing a condensed bar or cell pattern encoding said information onto the surface of the article.

2. A method in accordance with claim 1 wherein the condensed pattern is a two-dimensional barcode

3. A method in accordance with claim 2 wherein the two-dimensional barcode has a targeted final printed cell dimension, and wherein the condensed cell pattern comprises printed cells of a print area less than 100% of the target cell dimension.

4. A method in accordance with claim 3 comprising the further step of firing the condensed pattern to cause dilation of the printed cells to approach the target cell dimension.

5. A method for providing a fired ceramic article with a two-dimensional barcode marking which comprises the steps of:
imprinting a surface of a green preform for the ceramic article with a two-dimensional barcode having a condensed cell pattern comprising non-printed cells and condensed printed cells, and
firing the green preform to a temperature sufficient to convert the preform to the fired ceramic article and to convert the condensed cell pattern to a dilated cell pattern incorporating dimensionally expanded printed cells.

6. A method in accordance with claim 5 wherein the dilated cell pattern retains a cell contrast ratio of at least 20% between the dilated printed cells and the non-printed cells.

7. A method in accordance with claim 5 wherein the dilated cell pattern retains a cell contrast ratio of at least 50% between the dilated printed cells and the non-printed cells.

8. A method in accordance with claim 5 wherein the dilated cell pattern retains a cell contrast ratio of at least 80% between the dilated printed cells and the non-printed cells.

9. A method in accordance with claim 5 wherein the two-dimensional barcode has a data density sufficient to encode at least 6 alphanumeric characters.

10. A method in accordance with claim 9 wherein the two-dimensional barcode pattern does not exceed 10 cm×10 cm in size.

11. A method in accordance with claim 5 wherein condensed printed cells are squares.

12. A method in accordance with claim 5 wherein the condensed printed cells are circular.

13. An article of manufacture having a surface imprinted with a two-dimensional barcode marking, wherein:
the two dimensional barcode marking incorporates a cell pattern incorporating a combination of non-printed cells and condensed printed cells, and
the condensed printed cells have areas less than the areas of the non-printed cells.

14. An article in accordance with claim 13 which is a green ceramic honeycomb.

15. An article in accordance with claim 13 wherein each of the condensed printed cells has an area that is not more than 90% of the area of each of the non-printed cells.

16. An article in accordance with claim 13 wherein the two-dimensional barcode marking has a data density sufficient to encode at least 6 alphanumeric characters.

17. An article in accordance with claim 13 wherein the two-dimensional barcode marking does not exceed 10 cm×10 cm in size.

18. An article in accordance with claim 13 wherein condensed printed cells are squares.

19. An article in accordance with claim 13 wherein the condensed printed cells are circular.
